(19) United States
(12) Patent Application Publication
(10) Pub. No.: US 2009/0016623 A1
(43) Pub. Date: Jan. 15, 2009

(54) Image processing device, image processing method and program

(75) Inventor: Tetsuo Higewake, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/218,012

(22) Filed: Jul. 10, 2008

(30) Foreign Application Priority Data
Jul. 13, 2007 (JP) P2007-184975

(51) Int. Cl. G06K 9/50

(52) U.S. Cl. 382/236; 348/441

(57) ABSTRACT

There is provided an image processing device that is capable of performing a frame rate conversion of the coded data. The image processing device includes an encoded difference data decoding portion that decodes the coded data that is input into encoded difference data. The image processing device also includes an interpolated encoded difference data creation portion that creates interpolated encoded difference data that is inserted between frames in the encoded difference data, based on the encoded difference data. The image processing device also includes a frame rate conversion portion that performs a frame rate conversion of the encoded difference data using the interpolated encoded difference data.

### CROSS REFERENCES TO RELATED APPLICATION(S)

The present invention contains subject matter related to Japanese Patent Application JP 2007-184975 filed in the Japan Patent Office on Jul. 13, 2007, the entire contents of which being incorporated herein by reference.

### BACKGROUND OF THE INVENTION

1. Field of the Invention

The present invention relates to an image processing device, an image processing method and a program.

2. Description of the Related Art

In recent years, the rapid development of information processing technologies and information communication technologies has been accompanied by the spread of high-quality video and audio distribution services. However, the volume of high-quality video and audio data has become enormous. For that reason, technologies for distributing high-quality video and audio data economically have attracted attention. Much of that attention has been focused on technologies for distributing high-quality video that can be viewed on large, high-resolution television sets and the like. Active research is also underway on various types of coding technologies that compress the volume of the high-quality image data without reducing the image quality. One well-known example a compression coding technology is the data compression method standardized by the Moving Picture Experts Group (MPEG) and the Video Coding Experts Group (VCEG).

Incidentally, a representative example of a compression coding technology for image data is the technology called motion compensation. The processing involved in the motion compensation will be explained briefly. The processing includes a step of extracting a block in which the pixels are the same or most nearly the same among a plurality of frames. The processing also includes a step of computing a motion vector that expresses a direction of movement and an amount of movement for the block. The difference between two frames is then coded in the image data based on the motion vector computed by these steps. In this process, the pixels are compensated based on the computed motion vector. As a result, in a case where a block that contains the same or nearly the same pixels moves between frames, it is possible to reduce the volume of the image data without reducing the image quality. As an example of an application of this technology, a technology that performs a frame rate conversion and an interlaced-to-progressive conversion (IP conversion) is described in Japanese Patent Application Publication No. JP-A-2007-104652. This technology utilizes the motion vectors to create intermediate images for interpolation among the plurality of frames and inserts the intermediate images between the frames.

### SUMMARY OF THE INVENTION

However, the processing load for computing the motion vectors is greater than that for other processing, including the coding processing described above. It is therefore not easy to compute the motion vectors with high precision. Briefly consider, for example, processing to compute the motion vectors using a block matching method. In this processing, the first step is to compute the sum of the absolute values of the differences in the pixel values on a per-block basis, in relation to two reference frames. Next, the direction of movement and the amount of movement are computed for the block that corresponds to the lowest value among the sums of the absolute values of the differences. This determines the motion vectors. Consider, for example, a case in which the range is set to ±7 pixels horizontally and ±3 pixels vertically from the position of a given block and the processing is performed to compute the motion vector within that range by using the block matching method. The number of computation cycles to determine the motion vector for one pixel is “(computing the differences for 21 pixels+21 cycles of computing the absolute values+21 cycles of adding the absolute values)×15 pixels in the horizontal direction×7 pixels in the vertical direction”. In other words, a rough estimate of the resources necessary for these calculations, in terms of gates, is at least one million gates.

In light of these issues, various types of technologies have been studied to improve the block matching method and reduce the computing resources. However, no improvements have been made on the point of applying the block matching method to a frame that is decoded by decoding the coded data. The current reality is therefore that adequate ways have not been found to address the fundamental issue that a larger frame size requires greater computing resources.

For example, in the case of a frame with an image size of 1920×1080 pixels, the data volume is approximately 1900 Mbps. This sort of enormous data volume is itself a fundamental cause of the increase in computing resources. These numerical values are calculated on the assumption of an interlaced mode, a frame rate of 60 Hz, and a pixel data size of 30 bits. With other data formats, the data volume might exceed 1900 Mbps.

Accordingly, an embodiment of the present invention addresses these issues and provides an image processing device, an image processing method, and a program that are new and improved and that are capable of reducing the computing resources.

In order to resolve the above issues, according to an embodiment of the present invention, there is provided an image processing device, as described below, that is capable of performing a frame rate conversion of the coded data that is input. The image processing device includes an encoded difference data decoding portion that decodes the coded data into encoded difference data. The image processing device also includes an interpolated encoded difference data creation portion that creates interpolated encoded difference data that will be inserted between frames in the encoded difference data, based on at least one of the encoded difference data and the coded data. The image processing device also includes a frame rate conversion portion that performs a frame rate conversion of the encoded difference data using the interpolated encoded difference data.

The image processing device may also include an image signal restoration portion that decodes the encoded difference data that was converted by the frame rate conversion portion and restores an image signal in which the frame rate has been converted.

The image processing device may also include a high image quality processing portion that performs high image quality processing of the coded data.

In order to resolve the above issues, according to another embodiment of the present invention, there is provided an image processing method, as described below, that is capable of performing a frame rate conversion of the coded data that is input. The image processing method includes a step of decoding the coded data into encoded difference data. The image processing method also includes a step of creating interpolated encoded difference data that will be inserted between frames in the encoded difference data, based on at least one of the encoded difference data and the coded data. The image processing method also includes a step of performing a frame rate conversion of the encoded difference data using the interpolated encoded difference data.

In order to resolve the above issues, according to another embodiment of the present invention, there is provided a computer program that implements the functions of the image processing device in a computer. A storage medium in which the program mentioned above is stored is also provided.

The configurations described above reduce the computing resources that are used in performing the frame rate conversion processing, reduce the volume of the frame memory that is used in the processing, and improve the precision of the estimation of the motion vectors.

According to the embodiments of the present invention described above, it is possible to reduce the computing resources.

### BRIEF DESCRIPTION OF THE DRAWINGS

FIG. 1 is an explanatory figure that shows a principle of a frame rate conversion;

FIG. 2A is an explanatory figure that shows a principle of a block matching method;

FIG. 2B is another explanatory figure that shows the principle of the block matching method;

FIG. 2C is another explanatory figure that shows the principle of the block matching method;

FIG. 3 is an explanatory figure that shows a functional configuration of an image processing device that is capable of performing the frame rate conversion;

FIG. 4 is an explanatory figure that shows a functional configuration of an image processing device according to an embodiment of the present invention;

FIG. 5 is an explanatory figure that shows a frame rate conversion method according to the embodiment; and

FIG. 6 is an explanatory figure that shows an example of a hardware configuration of the image processing device according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [Overview of High-Quality Image Processing]

First, before the embodiments of the present invention are explained, high-quality image processing of image data using a motion vector will be briefly explained. Note that the high-quality image processing will be explained using a frame rate conversion as an example, but the range of application of the technology explained below is not limited to this example. For example, it can also be applied to IP conversion and the like. In the case of the IP conversion, the technology is applied to processing that interpolates a blank line in one of an odd-numbered interlaced image and an even-numbered interlaced image, based on a motion vector that is estimated from preceding and following interlaced images.

### (Frame Rate Conversion)

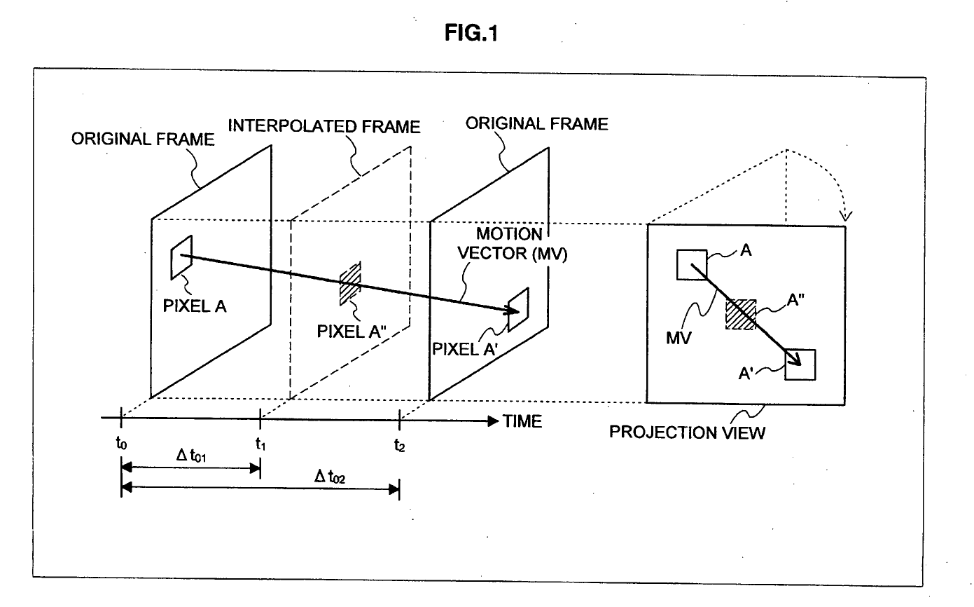

First, the frame rate conversion by an image processing device will be explained with reference to FIG. 1. FIG. 1 is an explanatory figure that explains a principle of the frame rate conversion. In FIG. 1, an example is shown of three frames that respectively correspond to times t₀, t₁, and t₂. In the explanation that follows, the frames that correspond to the times t₀ and t₂ are called original frames, and the frame that corresponds to the time t₁ is called an interpolated frame. The original frames are frames that contain the image data before the frame rate conversion is carried out. By contrast, the interpolated frame is a frame that is created by using the motion vector.

The frame rate conversion, as shown in FIG. 1, is a process that raises the time resolution of the image data by inserting the interpolated frame between the original frames. The interpolated frame is created based on pixel values in the original frames that correspond to the preceding and following times. To explain using the example in FIG. 1, a pixel A″ in the interpolated frame is computed based on a pixel A that is contained in the original frame for the time to and on a pixel A′ that is contained in the original frame for the time t₂ and that corresponds to the pixel A. The correspondence relationship between the pixel A and the pixel A′ is expressed by a motion vector MV. The motion vector is a vector quantity that expresses a direction in which a given pixel moves and the speed at which the pixel moves (a quantity of movement per unit time). Therefore, once the motion vector MV is computed, the image processing device can create in the interpolated frame the pixel A″ that corresponds to the pixel A and the pixel A′, based on the motion vector MV and on the time t₁ (that is, Δt₀₁, Δt₀₂) when the interpolated frame is inserted.

### (Block Matching Method)

The image processing device may estimate the motion vector using a block matching method, for example. The block matching method is a method that determines the value of each pixel in the original frames that serve as references (hereinafter called the “reference frames”), divides the reference frames into blocks of a specified size, computes the sum of the absolute values of the differences in the pixel values within each corresponding pair of blocks in the reference frames, and extracts the blocks that correspond to the lowest value among the sums of the absolute values of the differences.

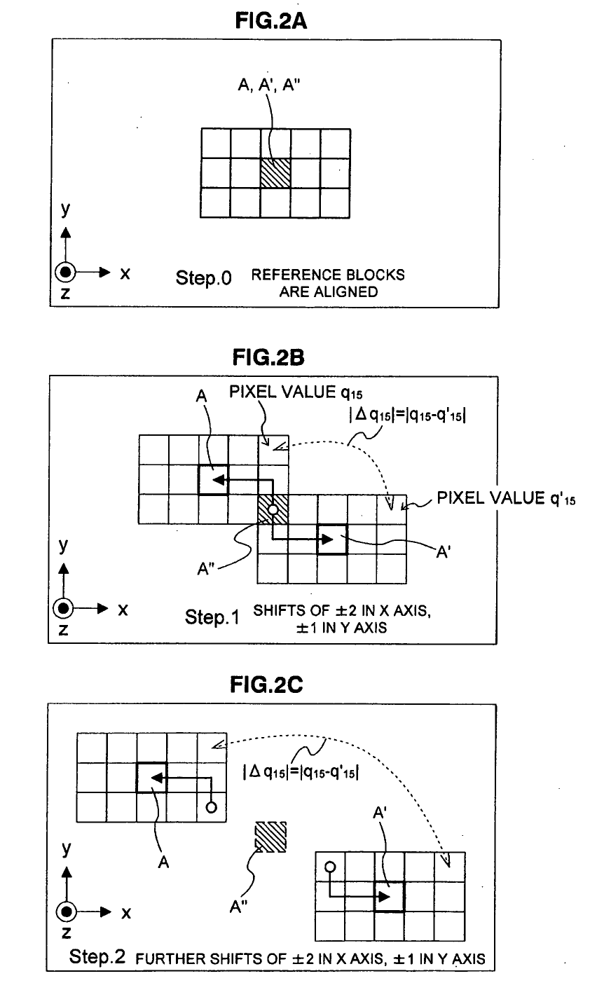

The block matching method will be explained briefly with reference to FIGS. 2A to 2C. FIGS. 2A to 2C are explanatory figures for explaining principles of the block matching method. In the example shown in FIGS. 2A to 2C, the block size is five pixels in the X axis direction and three pixels in the Y axis direction. Further, each of the figures in FIGS. 2A to 2C corresponds to the projection view in FIG. 1.

First, the image processing device sets each block such that the pixels A and A′ are aligned with the pixel A″ in the interpolated frame that the image processing device will create (Step 0 in FIG. 2A). Next, the image processing device moves the block that contains the pixel A (hereinafter called the “block A”) by a specified number of pixels in the X axis direction and the Y axis direction. In the same manner, the image processing device moves the block that contains the pixel A′ (hereinafter called the “block A′”) in the opposite direction from the direction in which the block A was moved. For example, the image processing device moves the block A −2 pixels in the X axis direction and +1 pixel in the Y axis direction. The image processing device then moves the block A′ +2 pixels in the X axis direction and −1 pixel in the Y axis direction. Thereafter, the image processing device computes the absolute value of the difference between each pixel in the block A and each corresponding pixel in the block A′.

AS shown in Step 1 in FIG. 2B, for example, the image processing device computes the absolute value of the difference between a pixel value q₁₅ that is positioned in the upper right corner of the block A (position (1, 5)) and a pixel value q′₁₅ that is positioned in the upper right corner of the block A′ (position (1, 5)) as |Δq₁₅|=|q₁₅−q′₁₅|. Note that the expression “position (i, j)” describes the position of a pixel that is located at the i-th position in the X axis direction and the j-th position in the Y axis direction, such that the position in the upper left corner of the block is position (1, 1). In the same manner as described above, the image processing device computes the absolute values of the differences between all of the pixels in the blocks A and A′ as |Δqᵢⱼ| (where i is an integer from 1 to 5 and j is an integer from 1 to 3). Then the image processing device adds up all of the absolute values of the differences |Δqᵢⱼ|, and computes the sum of the absolute values of the differences as S₁=Σ|Δqᵢⱼ|.

The image processing device then moves the blocks A and A′ again and computes the sum of the absolute values of the differences again. For example, the image processing device moves the block A −2 pixels in the X axis direction and +1 pixel in the Y axis direction from its position at Step 1 (FIG. 2B), and moves the block A +2 pixels in the X axis direction and −1 pixel in the Y axis direction. Then, in the same manner as it did at Step 1 (FIG. 2B), the image processing device computes, as |Δqᵢⱼ|, the absolute value of the difference between each of the pairs of pixels in the blocks A and A′ after they have been moved. Then the image processing device computes the sum of the absolute values of the differences as S₂=Σ|Δqᵢⱼ| (Step 2 in FIG. 2C).

Thereafter, in the same manner as at Step 1 (FIG. 2B) and Step 2 (FIG. 2C), the image processing device moves the blocks A and A′ to various positions and computes the sum of the absolute values of the differences as Sₖ=(where k=1, 2, . . . ). The image processing device then extracts the minimum value Sₘᵢₙ of the sums of the absolute values of the differences Sₖ. Next, the image processing device extracts the positions of the blocks A and A′ that correspond to the minimum value Sₘᵢₙ. Then, for the blocks A and A′ that correspond to the minimum value Sₘᵢₙ, the image processing device determines the vector that links the pixel A that is contained in the block A and the pixel A′ that is contained in the block A′ and defines it as a motion vector MV₀₂. The block matching method can be called a method that estimates the motion vector by moving the blocks in the reference frames (hereinafter called the “reference blocks”) and computes the sums of the absolute values of the differences between them.

In the example in FIGS. 2A to 2C, the directions in which the blocks are moved and the amounts of movement are described in approximate terms for the sake of the explanation, but the actual block matching is performed with the blocks being moved in units of one pixel or a small number of pixels in the ±X axis directions and the ±Y axis directions. In a case where the motion vector is estimated with high precision, the block matching is performed in all directions in finer pixel units. In the explanation that follows, the processing that uses one of the method described above and another method is simply called motion estimation.

As described above, the motion vector can be estimated according to a comparatively simple algorithm using the block matching method. However, the block matching method uses a large amount of computing resources for the processing that estimates the motion vector. Even in a case such as in FIGS. 2A to 2C, where the block matching is done by moving the reference blocks in a mutually symmetrical manner, the amount of computing that is done in the processing is enormous. For example, in a case of block matching where the amounts of movement are in one-pixel units and the distances moved are ±7 pixels in the X axis direction and ±3 pixels in the Y axis direction, the block size is 21 pixels. Thus the amount of computing to estimate one motion vector is (computation of the absolute values of the differences for 21 pixels+adding up the absolute values)×the amount of movement in the x axis direction (15 pixels)×the amount of movement in the Y axis direction (7 pixels). Therefore, the amount of computing, expressed in terms of gates, is more than one million gates. Accordingly, it is desirable to reduce the computing resources that are actually used for the frame rate conversion.

### (Functional Configuration of an Image Processing Device 10)

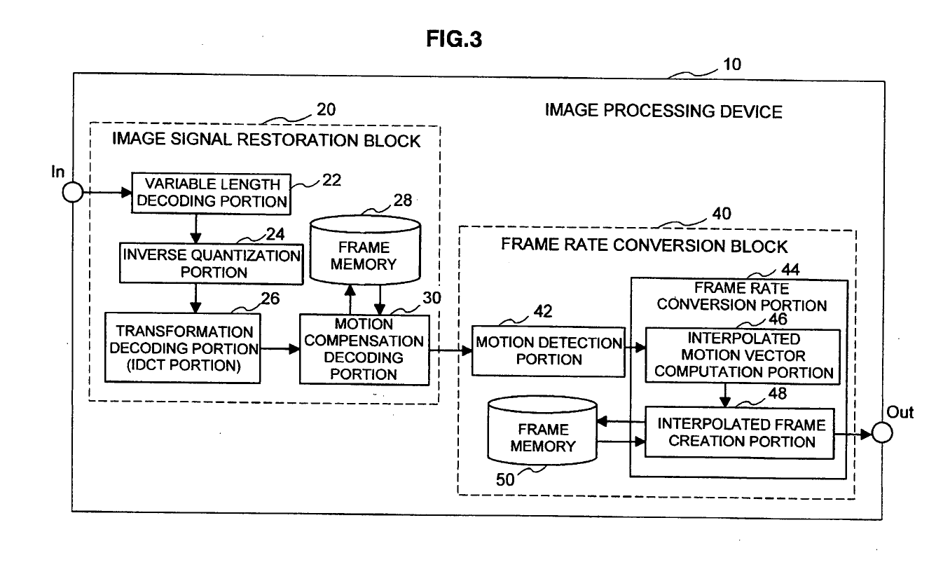

A functional configuration of an image processing device 10 that is capable of performing the frame rate conversion described above will be explained briefly with reference to FIG. 3. FIG. 3 is an explanatory figure that shows the functional configuration of the image processing device 10 that is capable of performing the frame rate conversion. Later, the functional configuration of the image processing device 10 described here will be explained in comparison with the functional configuration of an image processing device according to an embodiment of the present invention.

As shown in FIG. 3, the image processing device 10 is mainly configured from an image signal restoration block 20 and a frame rate conversion block 40. The image signal restoration block 20 is a functional block for taking coded data that is coded by a method such as MPEG, H.264, or the like, for example, and decoding the coded data into the original image signal. The frame rate conversion block 40 is a functional block for improving the image quality by performing the frame rate conversion on the image signal that has been decoded by the image signal restoration block 20.

### (The Image Signal Restoration Block 20)

The image signal restoration block 20 includes, for example, a variable length decoding portion 22, an inverse quantization portion 24, a transformation decoding portion 26, a frame memory 28, and a motion compensation decoding portion 30.

The variable length decoding portion 22 performs variable length decoding (VLD) of coded data (for example, an MPEG bit stream or the like) that is coded by variable length coding (VLC) and is input from an input terminal In. Next, the inverse quantization portion 24 performs an inverse quantization of the coded data that has been decoded by the variable length decoding of the variable length decoding portion 22. Next, the transformation decoding portion 26 performs an inverse discrete cosine transform (IDCT) of the inversely quantized coded data. Note that a transform method other than the DCT method (for example, the Karhunen-Loeve (KL) transform or the like) can be used for the method of transforming the coded data. In that case, the transformation decoding portion 26 would perform the inverse transform according to the other transform method.

Next, the motion compensation decoding portion 30 computes the motion vectors based on the coded data that has been decoded by the transformation decoding portion 26, then restores the original image signal based on the motion vectors. The motion compensation decoding portion 30 computes the motion vectors in macro-block units, for example. When doing so, the motion compensation decoding portion 30 utilizes the frame memory 28 to accumulate the frames. For example, the motion compensation decoding portion 30 may perform processing that restores the image signal by combining the frame images that are accumulated in the frame memory 28 with difference images that are computed based on the motion vectors. The motion compensation decoding portion 30 then transmits information on the restored image signal (for example, color values (Y, Cb, Cr) and the like) to the frame rate conversion block 40.

### (The Frame Rate Conversion Block 40)

The frame rate conversion block 40 mainly includes a motion detection portion 42, a frame rate conversion portion 44, and a frame memory 50. The frame rate conversion portion 44 mainly includes an interpolated motion vector computation portion 46 and an interpolated frame creation portion 48.

The motion detection portion 42 detects the motion vectors between the frames based on the image signal that is input from the image signal restoration block 20. The motion detection portion 42 may detect the motion vectors based on the block matching method or the like, for example.

The frame rate conversion portion 44 creates the interpolated frames that are inserted between the image signal frames, based on the motion vectors. By inserting the created interpolated frames between the image signal frames, the frame rate conversion portion 44 also converts the frame rate of the image signal. Based on the image signal received from the image signal restoration block 20 and the motion vectors that are detected by the motion detection portion 42, the frame rate conversion portion 44 computes interpolated motion vectors MVᵢₜₚ for the interpolated frames. For example, the interpolated motion vector computation portion 46 determines vector quantities that have the same direction as the original motion vectors and have lengths that are determined based on the ratio of the time interval between the reference frames and the time interval between the reference frames and the interpolated frame. In the explanation that follows, these vector quantities are called the interpolated motion vectors.

Next, the interpolated frame creation portion 48 uses the interpolated motion vectors that were created by the interpolated motion vector computation portion 46 to create the pixels in the interpolated frame. For example, the interpolated frame creation portion 48 may move the pixels in the reference frames based on the interpolated motion vectors, then define the pixels after the move as the pixels in the interpolated frame. In doing so, the interpolated frame creation portion 48 creates the interpolated frame with reference to the reference frames that are accumulated in the frame memory 50. The interpolated frame creation portion 48 also inserts the interpolated frame to create the image signal. The image signal for which the frame rate has been converted is output to an output terminal Out.

The functional configuration of the image processing device 10 has been briefly explained. The functional configuration described above makes it possible to perform the frame rate conversion of the image signal, but because of the large amount of computing resources that are used for the processing in the motion detection portion 42, the separate frame memory 50 is used for the creation of the interpolated frame. This increases the product cost of the image processing device 10 itself. An embodiment of the present invention that limits the amount of the computing resources and the product cost will be explained in detail below.

### Embodiment of the Present Invention

An embodiment of the present invention will be explained. A feature of the present embodiment is that the frame rate conversion is performed at a stage prior to the decoding of the coded data in which the difference between two frames is coded. This reduces the computing resources that are used in the creation of the interpolated motion vectors and also reduces the volume of the frame memory that is used in the creation of the image signal in which the frame rate is converted.

### [Functional Configuration of an Image Processing Device 100]

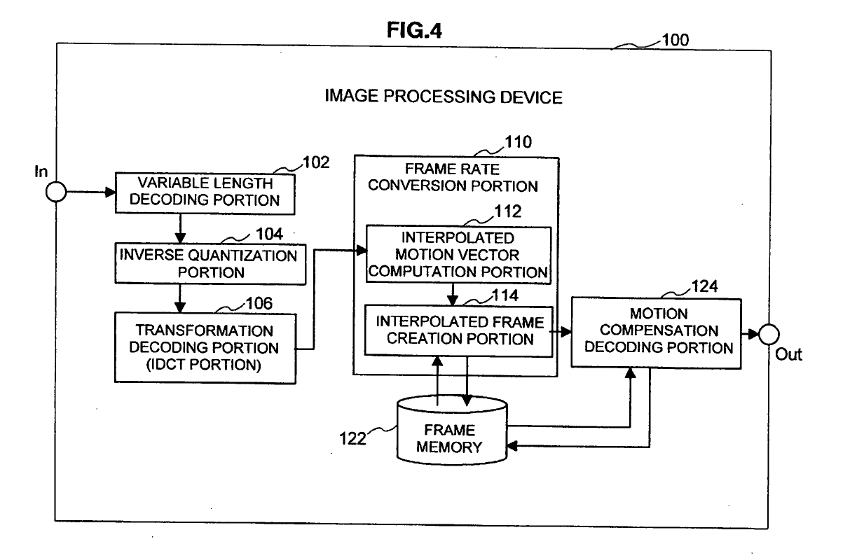

A functional configuration of an image processing device 100 according to the present embodiment will be explained with reference to FIG. 4. FIG. 4 is an explanatory figure that shows the functional configuration of the image processing device 100 according to the present embodiment.

As shown in FIG. 4, the image processing device 100 includes a variable length decoding portion 102, inverse quantization portion 104, a transformation decoding portion 106, a frame rate conversion portion 110, a frame memory 122, and a motion compensation decoding portion 124. Further, the frame rate conversion portion 110 includes an interpolated motion vector computation portion 112 and an interpolated frame creation portion 114.

The variable length decoding portion 102 decodes coded data that is coded by variable length coding and is input from an input terminal In. Next, the inverse quantization portion 104 performs the inverse quantization of the coded data that has been decoded by the variable length decoding of the variable length decoding portion 102. Next, the transformation decoding portion 106 performs the inverse discrete cosine transform of the inversely quantized coded data. Note that a transform method other than the DCT method (for example, the KL transform or the like) may be used for the method of transforming the coded data. In that case, the transformation decoding portion 106 would perform the inverse transform according to the other transform method.

The transformation decoding portion 106 outputs an image signal that is data in which the difference between two frames is coded (hereinafter called the “encoded difference data”). The image processing device 10 described above performs the motion compensation on the encoded difference data to restore the original image signal, then performs the frame rate conversion. However, as described later, the image processing device 100 according to the present embodiment restores the image signal by directly creating interpolated encoded difference data that is inserted between the frames of the encoded difference data. The functional configurations of the image processing device 100 according to the present embodiment and the image processing device 10 clearly differ in this respect.

The frame rate conversion portion 110, based on the motion vectors in the encoded difference data that is obtained from the coded data, creates an interpolated encoded difference frame that is inserted between the frames of the encoded difference data. By inserting the interpolated encoded difference frame that it creates between the frames of the encoded difference data, the frame rate conversion portion 110 converts the frame rate of the coded data.

The interpolated motion vector computation portion 112 computes the motion vectors that correspond to the interpolated encoded difference frame (hereinafter called the “interpolated motion vectors”) based on the motion vectors for the pixels that are contained in the encoded difference data. For example, the interpolated motion vector computation portion 112 computes the interpolated motion vectors that have the same direction as the original motion vectors and have lengths that are determined based on the ratio of “the time interval between the reference frames” and “the time interval between the reference frame and the interpolated frame”.

Next, the interpolated frame creation portion 114 create the pixels for the interpolated encoded difference frame by using the interpolated motion vectors that have been computed by the interpolated motion vector computation portion 112. For example, based on the interpolated motion vectors, the interpolated frame creation portion 114 may move the pixels in the encoded difference data to which it refers, then define the pixels after the move as the pixels in the interpolated encoded difference frame.

In this process, the interpolated frame creation portion 114 creates the interpolated encoded difference frame by referring to the encoded difference data that is accumulated in the frame memory 122. The interpolated frame creation portion 114 also inserts the interpolated encoded difference frame into the encoded difference data, thus creating the encoded difference data for which the frame rate has been converted.

The interpolated frame creation portion 114 then inputs to the motion compensation decoding portion 124 the encoded difference data for which the frame rate has been converted. Note that the interpolated motion vectors described above are accumulated in the frame memory 122 and are used in processing by the motion compensation decoding portion 124, which is described later.

Next, the motion compensation decoding portion 124 creates an image signal based on the encoded difference data that has been input from the interpolated frame creation portion 114 and on the interpolated motion vectors that have been accumulated in the frame memory 122. Note that because both the original frames in the encoded difference data and the interpolated encoded difference frame are already contained in the encoded difference data, the image signal that is output has already had its frame rate converted.

### (Frame Rate Conversion Method)

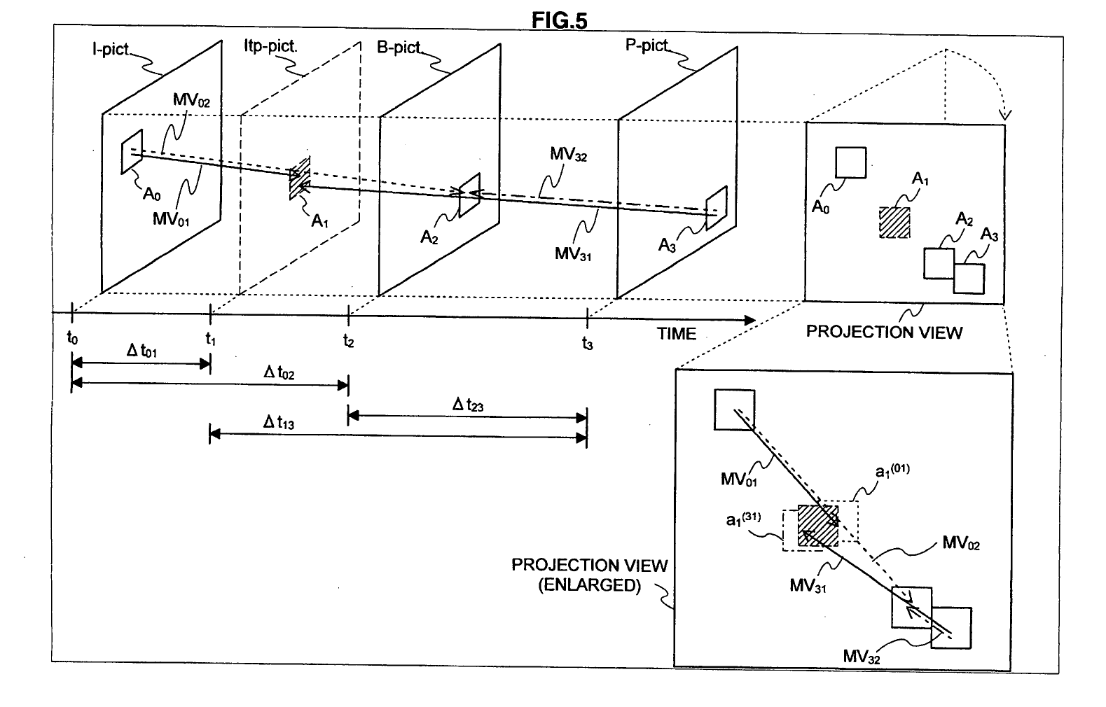

The frame rate conversion method according to the present embodiment will be explained in concrete terms with reference to FIG. 5. FIG. 5 is an explanatory figure that shows a specific example of the frame rate conversion method according to the present embodiment. Note that the method is implemented by the frame rate conversion portion 110.

FIG. 5 shows an I-picture frame (I-pict.) that corresponds to a time t₀, a B-picture frame (B-pict.) that corresponds to a time t₂, a P-picture frame (P-pict.) that corresponds to a time t₃. This example shows a method of performing the frame rate conversion that inserts an interpolated frame (Itp-pict.) between the I-picture frame and the B-picture frame. Assume that the B-picture frame at the time t₂ is a frame that has been restored using the I-picture frame at the time to and the P-picture frame at the time t₃ as the reference frames (bi-directional referencing). Substantially the same method can be applied even in cases of forward referencing and backward referencing.

Further, MV₀₂ indicates a motion vector from a pixel A₀ in the I-picture frame to a pixel A₂ in the B-picture frame, and MV₃₂ indicates a motion vector from a pixel A₃ in the P-picture frame to the pixel A₂ in the B-picture frame. The motion vectors (MV₀₂, MV₃₂) are obtained from the coded data that is input. Accordingly, the interpolated motion vector computation portion 112 computes interpolated motion vectors MV₀₁ and MV₃₁ that correspond to the interpolated frame, based on a time of the interpolated frame (the time that the interpolated frame is created).

For example, based on the ratio of the time interval Δt₀₁=t₁−t₀ between the I-picture frame and the interpolated frame and the time interval Δt₀₂=t₂−t₀ between the I-picture frame and the B-picture frame, the interpolated motion vector computation portion 112 creates the interpolated motion vector MV₀₁ by multiplying the length of the motion vector MV₀₂ by Δt₀₁/Δt₀₂. In the same manner, the interpolated motion vector computation portion 112 creates the interpolated motion vector MV₃₁ by multiplying the length of the motion vector MV₃₂ by Δt₁₃/Δt₂₃, based on the time intervals between the interpolated frame, the B-picture frame, and the P-picture frame. In other words, MV₀₁=MV₀₂×(Δt₀₁/Δt₀₂), and MV₃₁=MV₃₂×(Δt₁₃/Δt₂₃).

Using the method explained above, the interpolated motion vector computation portion 112 computes the interpolated motion vectors for all of the macro blocks that are contained in the interpolated encoded difference frame. Header information in the original coded data may also be updated in this process.

Next, the interpolated frame creation portion 114 creates a pixel a₁⁽⁰¹⁾ in the interpolated frame by moving the pixel A₀ in the I-picture frame based on the interpolated motion vector MV₀₁, for example (referencing a projection view). In the same manner, the interpolated frame creation portion 114 creates a pixel a₁⁽³¹⁾ in the interpolated frame by moving the pixel A₃ in the P-picture frame based on the interpolated motion vector MV₃₁, for example. Then the interpolated frame creation portion 114 creates a pixel A₁ in the interpolated frame by averaging the pixel value of the pixel a₁⁽⁰¹⁾ and the pixel value of the pixel a₁⁽³¹⁾ in the interpolated frame.

Note that the interpolated frame creation portion 114 may also create the pixel A₁ in the interpolated frame by giving more weight, in the averaging of the pixel values, to the interpolated motion vector MV₀₁ that was computed based on the I-picture frame. The motion compensation decoding portion 124 outputs the restored I-picture frame, the interpolated frame, the B-picture frame, and the P-picture frame in that order. The processing described above outputs the image signal with a high frame rate.

The functional configuration of the image processing device 100 according to the present embodiment and the frame rate conversion method have been explained above. Applying the technologies described above makes it possible to omit processing that corresponds to that done by the motion detection portion 42 of the image processing device 10. Further, the frame rate conversion can be performed using less memory volume in the frame memory and fewer computing resources. Moreover, unlike the image processing device 10, the image processing device 100 according to the present embodiment does not perform detection of the motion vectors internally. Therefore, the precision of the interpolated frame does not depend on internal motion vector detection performance. This makes it possible for the image processing device 100 according to the present embodiment to create an interpolated frame that is closer to the original image than is the interpolated frame created by the image processing device 10.

### [Hardware Configuration]

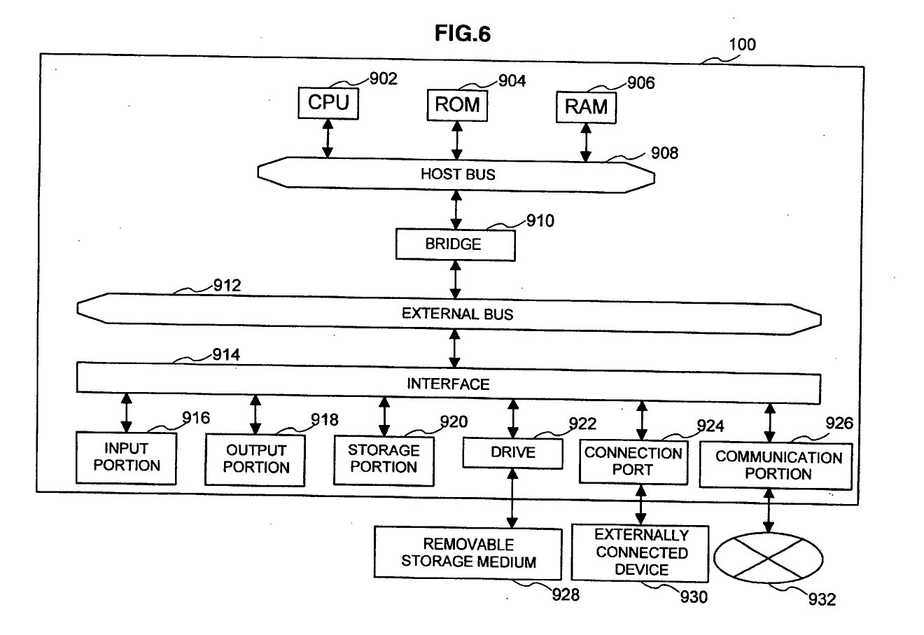

The functions of the various configuring elements of the image processing device 100 can be implemented in an information processing device that has a hardware configuration like that shown in FIG. 6. FIG. 6 is an explanatory figure that shows a hardware configuration of an information processing device that can implement the functions of the various configuring elements of the image processing device 100.

As shown in FIG. 6, the information processing device mainly includes a central processing unit (CPU) 902, a read only memory (ROM) 904, a random access memory (RAM) 906, a host bus 908, a bridge 910, an external bus 912, an interface 914, an input portion 916, an output portion 918, a storage portion 920, a drive 922, a connection port 924, and a communication portion 926.

The CPU 902 functions as at least one of a computation processing device and a control device, for example, and controls one of all or a part of the operations of the various configuring elements, based on various types of programs that are stored in at least one of the ROM 904, the RAM 906, the storage portion 920, and a removable storage medium 928. The ROM 904 stores data and the like that are used by computations and by programs that are read by the CPU 902, for example. The RAM 906 stores, at least one of temporarily and permanently, the programs that are read by the CPU 902, as well as various types of parameters and the like that vary as necessary when the programs are executed, for example. These configuring elements are interconnected by the host bus 908, for example, which is capable of high speed data transmission. The host bus 908 is connected through the bridge 910 to the external bus 912, whose data transmission speed is comparatively low.

The input portion 916 is an operation portion such as a mouse, a keyboard, a touch panel, a button, a switch, a lever, or the like, for example. The input portion 916 may also be a remote control portion (what is called a remote control) that is capable of transmitting a control signal using infrared light or another electromagnetic wave. The input portion 916 also includes an input control circuit for transmitting to the CPU 902, as an input signal, information that is input using the operation portion described above.

The output portion 918 is a device that is capable of at least one of visibly and audibly notifying a user of information that has been obtained. The output portion 918 may be, for example, a display device, such as a cathode ray tube (CRT), a liquid crystal display (LCD), a plasma display panel (PDP), an electro-luminescence display (ELD), or the like, an audio output device such as a speaker, a headphone, or the like, a printer, a mobile telephone, a facsimile machine, or the like.

The storage portion 920 is a device for storing various types of data. The storage portion 920 may be configured from a magnetic storage device such as a hard disk drive (HDD) or the like, a semiconductor storage device, an optical storage device, a magneto optical storage device, or the like, for example.

The drive 922 is a device that at least one of reads information from and writes information to the removable storage medium 928, which is a magnetic disk, an optical disk, a magneto optical disk, a semiconductor memory, or the like, for example. The removable storage medium 928 may be a DVD medium, a Blu-ray medium, an HARD-DVD medium, a Compact Flash (CF) card, a memory stick, a Secure Digital (SD) memory card, or the like, for example. Of course, the removable storage medium 928 may also be an electronic device, an integrated circuit (IC) card that carries a non-contact IC chip, or the like.

The connection port 924 is a port such as a Universal Serial Bus (USB) port, an IEEE 1394 port, a Small Computer System Interface (SCSI) port, an RS-232C port, or the like for connecting to an externally connected device 930. The externally connected device 930 may be a printer, a portable music player, a digital camera, a digital video camera, an IC recorder, or the like, for example.

The communication portion 926 is a communication device for connecting to a network 932 and may be, for example, a communication card for a wired or wireless local area network (LAN), for Bluetooth®, or for Wireless USB, a router for optical communication, a router for an Asymmetric Digital Subscriber Line (ADSL), a modem for various types of communication, or the like. The network 932 to which the communication portion 926 is connected is a network that is connected by wire or wirelessly and may be, for example, the Internet, a home LAN, an infrared communication network, a broadcast network, a satellite communication network, or the like.

It should be understood by those skilled in the art that various modifications, combinations, sub-combinations and alterations may occur depending on design requirements and other factors insofar as they are within the scope of the appended claims or the equivalents thereof.

For example, the explanation up to this point has been focused on MPEG coded data, but the technology according to the embodiment described above can also be applied to a system that has a decoder for a different type of coded data, such as H.264/AVC coded data or the like. In the case of H.264/AVC coded data, for example, the coded data for the B-picture frame is used as the reference frame for any number of frames. However, as explained for the embodiment described above, the frame rate conversion technology according to the embodiment described above can be applied by computing the motion vectors according to the ratio of the creation times for the reference frame and the interpolated frame.

As another example, the technology according to the embodiment described above can be modified such that a motion vectors in relation to a past frame is referenced when the pixels of the interpolated frame are created, and at least one of the interpolated motion vectors and the pixels of the interpolated frame are created based on a plurality of the motion vectors. This modification makes it possible for the motion compensation to be performed with greater precision.

Furthermore, the image signal is made smoother and its resolution is improved by performing high image quality processing on the input coded data to improve sharpness and the like, so a high quality image signal can be produced even in a case where the precision of the motion vector for the interpolated encoded difference frame is poor. This inhibits the effect of an increased size for the output display image.

What is claimed is:

1. An image processing device that is capable of performing a frame rate conversion of coded data that is input, comprising:
an encoded difference data decoding portion that decodes the coded data into encoded difference data;
an interpolated encoded difference data creation portion that creates interpolated encoded difference data that will be inserted between frames in the encoded difference data, based on at least one of the encoded difference data and the coded data; and
a frame rate conversion portion that performs a frame rate conversion of the encoded difference data using the interpolated encoded difference data.

2. The image processing device according to claim 1, further comprising:
an image signal restoration portion that decodes the encoded difference data that was converted by the frame rate conversion portion and restores an image signal in which the frame rate has been converted.

3. The image processing device according to claim 1, further comprising:
a high image quality processing portion that performs high image quality processing of the coded data.

4. An image processing method that is capable of performing a frame rate conversion of coded data that is input, including the steps of:
decoding the coded data into encoded difference data;
creating interpolated encoded difference data that will be inserted between frames in the encoded difference data, based on at least one of the encoded difference data and the coded data; and
performing a frame rate conversion of the encoded difference data using the interpolated encoded difference data.

5. A computer program comprising programming instructions to control a computer to convert a frame rate of coded data that is input and to function as:
an encoded difference data decoding portion that decodes the coded data into encoded difference data;
an interpolated encoded difference data creation portion that creates interpolated encoded difference data that will be inserted between frames in the encoded difference data, based on at least one of the encoded difference data and the coded data; and
a frame rate conversion portion that performs a frame rate conversion of the encoded difference data using the interpolated encoded difference data.

6. The program according to claim 5, further comprising programming instructions to control a computer to function as:
an image signal restoration portion that decodes the encoded difference data that was converted by the frame rate conversion portion and restores an image signal in which the frame rate has been converted.

7. The program according to claim 5, further comprising programming instructions to control a computer to function as:
a high image quality processing portion that performs high image quality processing of the coded data.
